(19) United States
(12) Patent Application Publication
(10) Pub. No.: US 2026/0367265 A1
(43) Pub. Date: Nov. 19, 2026

(54) VIBRATORY TRUCK CHASSIS CONFIGURATION AND METHOD

(71) Applicant: SERCEL, Carquefou (FR)

(72) Inventors: Gilles CARADEC, Cazere (FR); Didier SOUM, Carquefou (FR); Jérémy RESPECTE, Carquefou (FR); Florent NOGUES, Carquefou (FR)

(21) Appl. No.: 19/208,811

(22) Filed: May 15, 2025

(51) Int. Cl. G01V 1/09

(52) U.S. Cl. CPC G01V 1/09

(57) ABSTRACT

A vibratory chassis for supporting a baseplate assembly for generating seismic signals includes a cage having a flat bottom, the cage defining an opening, first and second longitudinal beams each attached with one end to the cage, and a connecting mechanism attached to the cage and configured to attach the chassis to a cabin part of a truck.

### BACKGROUND

### Technical Field

Embodiments of the subject matter disclosed herein generally relate to seismic data acquisition methods and systems and, more particularly, to a flat vibratory truck chassis that is configured to accommodate different mass baseplate assemblies for generating seismic waves with various characteristics.

### Discussion of the Background

Seismic data acquisition and processing generate a profile (image) of subterranean geophysical structures. While this profile does not provide an accurate location of oil and gas reservoirs, it suggests, to those trained in the field, the presence or absence of these reservoirs. Thus, providing a high-resolution image of the geophysical structures is an ongoing process.

To obtain a high-resolution image of the underground, a seismic survey system employs a seismic source that generates seismic waves, and seismic receivers that record seismic signals associated with the seismic waves. The seismic source imparts energy to the ground. The energy travels through the subsurface and gets reflected from certain subsurface geological formations, e.g., boundaries or layers or faults. The reflected energy travels back to the surface, where the seismic receivers record it. The recorded data is processed to yield information about the location and physical properties of the layers and faults making up the subsurface.

For land explorations, the seismic source may be a vibratory source. The energy transmitted by the vibratory source, through a baseplate, to the ground is proportional with the force acting on the baseplate. For land seismic surveys, it is desirable to transmit as much energy as possible to the ground. Thus, the heavier the truck carrying the vibratory source, the more weight is available to keep the baseplate in contact with the earth, enabling larger actuators to be used to drive the baseplate to transmit more vibratory energy into the earth.

Large hydraulic vibrators mounted on vehicle carriers equipped with tires or tracks are commonly used for geophysical exploration. Such a vehicle is called in this document a vibratory truck. Typically, a vibratory truck 100, as illustrated in FIG. 1, moves on ground to a pre-determined shot point, where it needs to impart energy into the ground. The vibratory truck 100 uses a lift system 110 to lower a baseplate 120 that couples vibratory energy into the earth 102 (the dash line in the figure shows the baseplate being coupled to the earth). A static hold-down force is also applied to the baseplate 120 to preload it, using a portion of the vibratory truck’s weight so that during a sweep, the baseplate 120 remains in good contact with the earth. A vibratory mechanism 112 then generates a sweep that typically lasts a couple of seconds (for example 8-16s, but in some cases may be shorter or last up to 60s) to produce a seismic signal 124 useful for illuminating subterranean features 125 (e.g., a fault, an oil reservoir, a layer interface, etc.). Reflected waves 126 (reflected off from the subterranean features 125) are then recorded by plural receivers 128 (only one shown in the figure for simplicity) as seismic signals. The receiver 128 may be a geophone, accelerometer, gravity sensor, etc. Typically, the receivers 128 are placed away (meters to thousands of meters) from the vibratory truck 100. The distance between the receiver and the vibratory truck in the figure is not at scale.

After the sweep is completed, the baseplate 120 is raised, and the vibratory truck 100 moves to the next shot point and the process repeats. During a typical day of seismic acquisition, the vibratory truck spends a large time hammering the baseplate to transmit the energy to the earth.

Large land vibrators in common use today are capable of full energy output over the range of about 7-90 Hz. Outside this frequency band, the maximum deliverable vibratory force (ground force) is limited due to constraints imposed by limiting factors in the mechanical and/or hydraulic system. To generate this energy, the vibrator mechanism 112 (which may include a reactive mass, a hydraulic pump, hydraulic lines, and one or more hydraulic pistons) generates an up and down movement of the reactive mass, which is mechanically transmitted to the baseplate 120. These up and down movements can become very intense for low frequencies and a large amount of energy is transferred to the baseplate in a rough manner. This energy transfer from the vibrator mechanism to the baseplate, for certain frequencies, can be described as an act of “hammering” the baseplate. Note that because the baseplate 120 typically has a large surface area (up to 1 m²) and because the baseplate 120 needs to move up when the vibratory truck moves to a next shooting point, the chassis 130 of the vibratory truck 100 is shaped as an arch (see FIG. 1 and especially FIG. 2) to accommodate the movement of the baseplate and/or the entire vibratory assembly. Although some vibratory trucks allow the baseplate to move through an opening formed in the chassis, this is the case for small surface area baseplates (i.e., light weight vibratory assemblies) as the opening’s area is limited by the structural characteristics of the chassis.

The baseplate 120 is typically made of one large, single, slab 122 of metal or composite material (see, for example, U.S. Patent nos. 8,913,465, 11,698,470) that is flat and smooth and has a large surface area (e.g., up to 1 m²), and this slab is configured to directly contact the ground 102. The intensity of the generated seismic waves depends on the mass of the baseplate 120 and the mass of the reactive mass. Thus, various seismic surveys require differently sized baseplates 120. Differently sized baseplates 120 require correspondingly sized vibratory mechanisms 112 and lift systems 110. Therefore, the operator of the vibratory truck needs to have different size vibratory trucks for supplying the necessary baseplate. However, maintaining a fleet of different vibratory trucks is expensive and not efficient as not all the vibratory trucks may be used during a single seismic survey.

Thus, there is a need for developing a seismic vibratory truck that overcomes the problems mentioned above with regard to the various size baseplates.

### SUMMARY

According to an embodiment, there is a vibratory truck chassis for supporting a baseplate assembly for generating seismic signals. The vibratory truck chassis includes a cage having a flat bottom, the cage defining an opening, first and second longitudinal beams each attached with one end to the cage, and a connecting mechanism attached to the cage and configured to attach the chassis to a cabin part of a truck.

According to another embodiment, there is a vibratory truck for supporting a baseplate assembly for generating seismic signals. The vibratory truck includes a flat chassis having a cage with a flat bottom, the cage defining an opening, a baseplate for contacting a ground, and a vibratory mechanism configured to act on the baseplate to generate the seismic signals. The opening is sized to allow the baseplate and the vibratory mechanism to fully pass through the opening for various weights of the baseplate and the vibratory mechanism.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a truck-mounted vibratory source;

FIG. 2 is a schematic diagram of a truck-mounted vibratory source having a chassis arched to allow a baseplate to move up and down;

FIG. 3 is a schematic diagram of a truck-mounted vibratory source having a flat chassis with tubular elements that allow a baseplate to move up and down through an opening in the flat chassis;

FIG. 4 is a schematic diagram of the flat chassis of FIG. 3;

FIGS. 5 and 6 illustrate the flat chassis of FIG. 3 having the opening defined by tubular elements;

FIGS. 7A-7C illustrate various details of the flat chassis having tubular elements defining the opening;

FIGS. 8 and 9 illustrate a baseplate and the associated vibratory mechanism in relationship to the flat chassis; and

FIG. 10 is a flow chart of a method for using a vibratory truck with a flat chassis with multiple baseplate assemblies.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a vibratory source mounted on a truck. However, the embodiments to be discussed next are not limited to this system, but may be applied to any vibratory source used to generate seismic waves, even if not mounted on a truck.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a vibratory truck has an enhanced chassis configured to support various size baseplates, to allow baseplates of various weights to pass through an opening configured into the chassis, and/or to maintain a flat profile of the chassis around the opening. The chassis is also configured to allow swapping various baseplates and associated vibratory mechanisms, depending on the needs of the seismic survey. Thus, a same flat chassis of the vibratory truck may be used with a light or heavy baseplate and associated baseplate assembly.

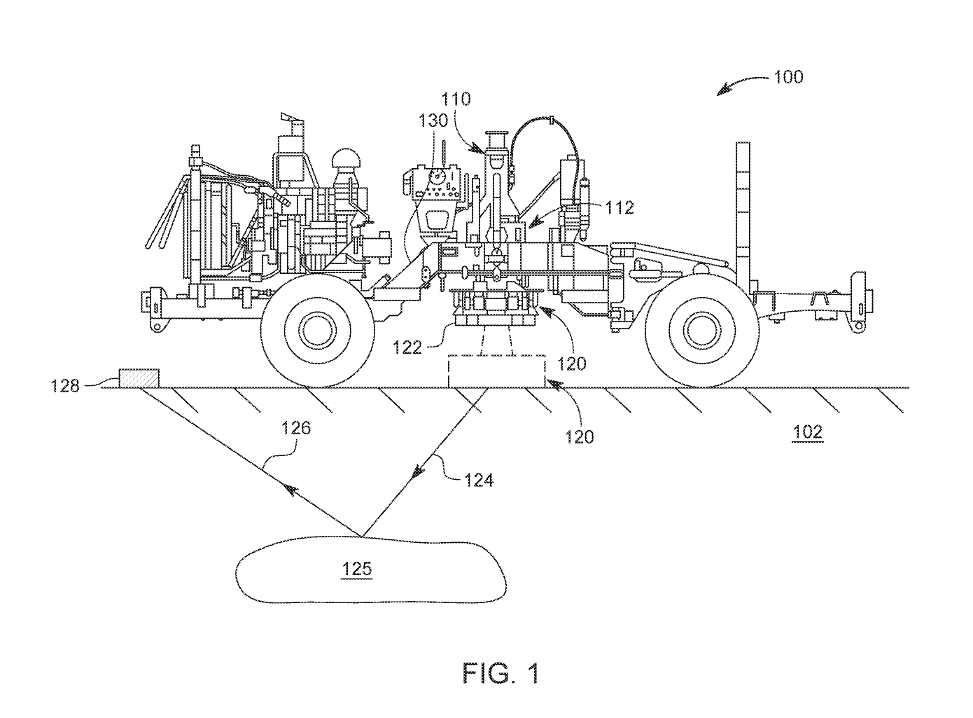

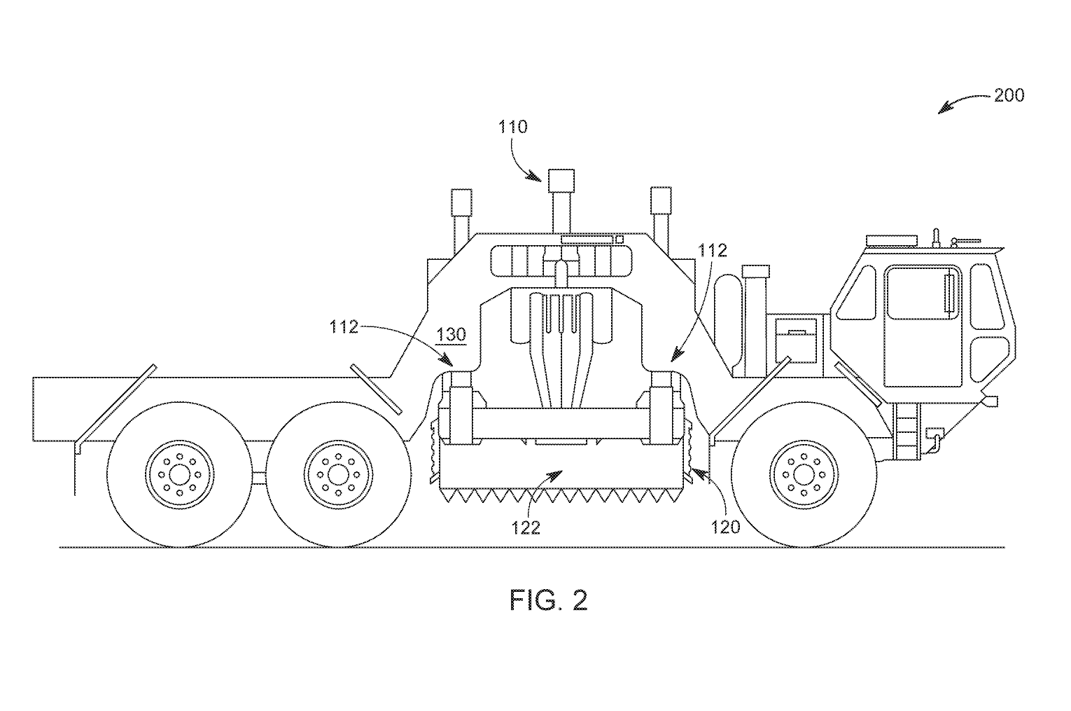

The existing vibratory trucks have different chases depending on the weight of the baseplate assembly. The baseplate assembly may include the baseplate 120 and the vibratory mechanism 112 shown in FIG. 1. For example, the baseplate assembly may weigh between 9 and 12 tons. As this is a large mass and especially because the baseplate is moved up and down by the vibratory mechanism 112, extra stress (in addition to the static weight of the baseplate assembly and part of the weight of the vibratory truck) is applied to the chassis of the truck. For this reason, depending the mass of the baseplate assembly, the structure of the chassis is different from truck to truck. Although attempts have been made for having a single chassis for all the existing baseplate assemblies, they have failed because the large amount of material necessary for supporting the largest baseplate assembly does not justify the cost of such a chassis. In addition, the existing chassis configurations do not allow a large mass baseplate assembly (e.g., 12 tons) to move up and down through a corresponding opening formed in the chassis without bending the chassis. Forming an arched chassis 130 as schematically illustrated in FIG. 2, for allowing the baseplate 120 to move up and down, without passing through an opening of the chassis, is not desirable because this specific configuration requires a heavy chassis, which place a large strain on the other components of the truck.

The inventors have discovered that it is possible to configure and manufacture a single type of chassis that can accommodate both large and small baseplate and associated baseplate assemblies, allow the baseplate assembly to move through an opening formed in the chassis, and offers a flat design.

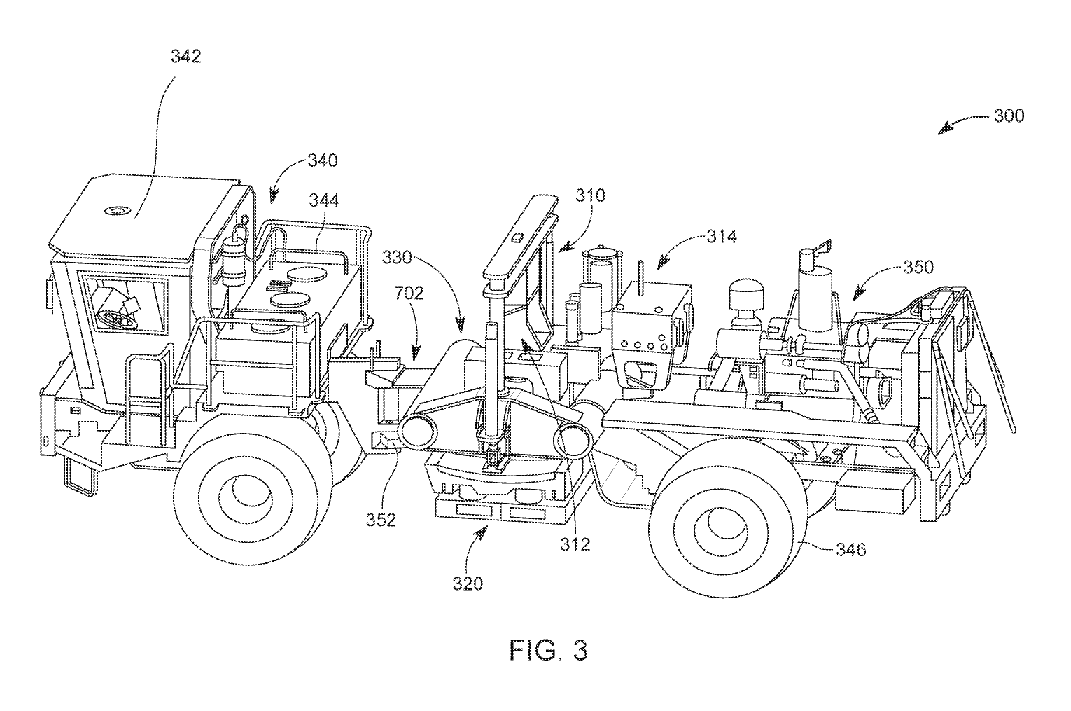

More specifically, FIG. 3 shows a vibratory truck 300 that includes a flat design chassis 330 that accommodates the movement of a large surface area baseplate 320, and the associated vibratory mechanism 312 through an opening. The baseplate 320 and the associated vibratory mechanism 312 are referred to herein as the baseplate assembly. A lifting system 310 is attached to the chassis 330, as discussed later, and is configured to raise or lower the baseplate 320 and at least a part of the vibratory mechanism 312. The flat chassis 330 is configured with support elements (not shown) for attaching a hydraulic pump 314 and associated tubing and hoses. The flat chassis 330 is also configured for supporting the back wheels 346 of the vibratory truck 300. An engine 350 that propels the vibratory truck is also attached to the chassis 330.

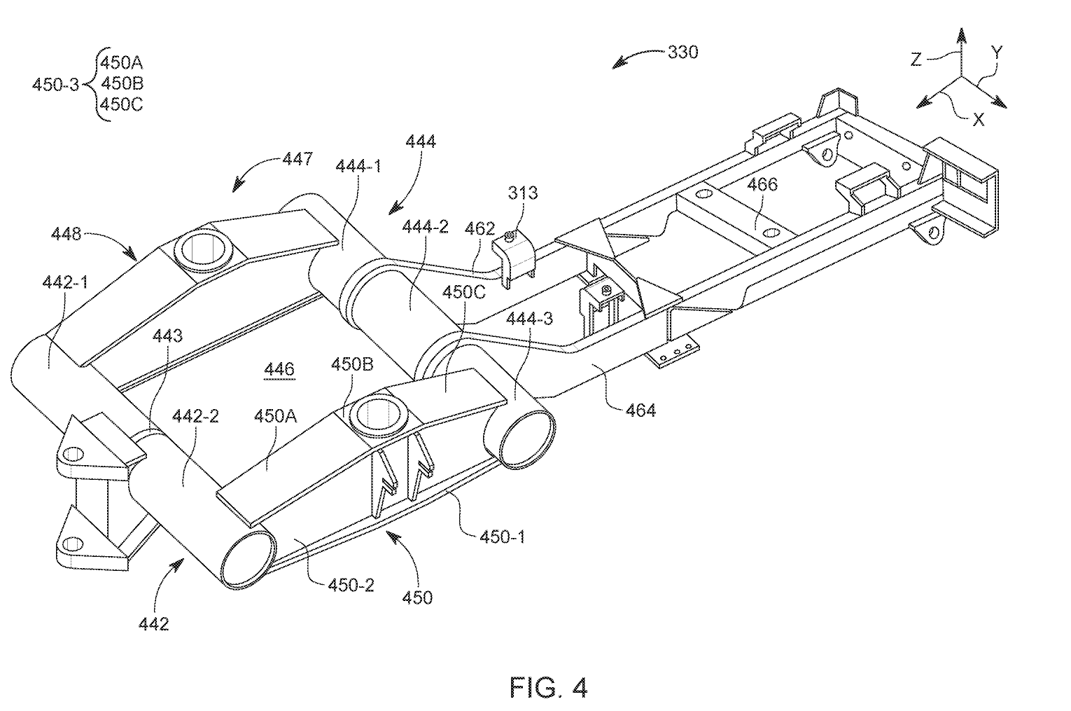

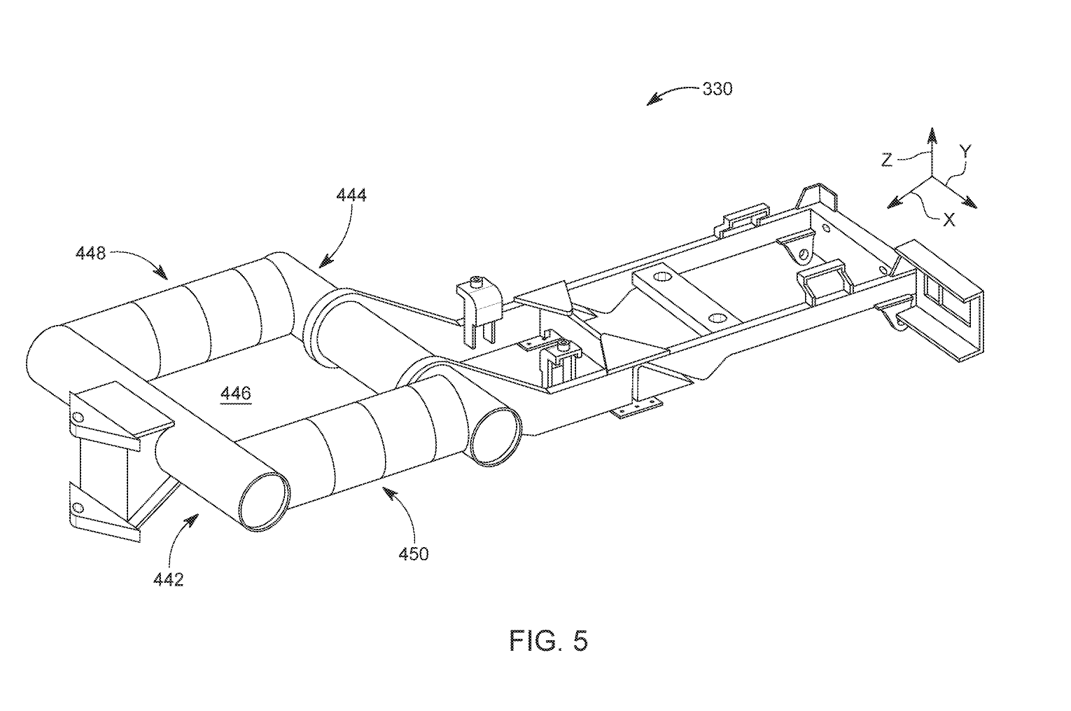

The configuration of the flat chassis 330 is better shown in FIG. 4. This figure shows that two parallel, transversal tubular elements 442 and 444 form two opposite sides of a large opening 446 through which the baseplate 320 and the vibratory mechanism 312 may move up and down. The two transversal tubular elements 442 and 444 are connected to each other through two connecting elements 448 and 450. FIG. 4 shows the two connecting elements 448 and 450 being made to have planar faces while FIG. 5 shows the same two connecting elements 448 and 450 being tubular, similar to the tubular elements 442 and 444. The transversal tubular elements 442 and 444 are substantially perpendicular to a longitudinal axis X of the chassis 330 while the connecting elements 448 and 450 are substantially parallel to the longitudinal axis X. Thus, in one embodiment, adjacent elements of the elements 442-450 make 90 degrees angles with each other.

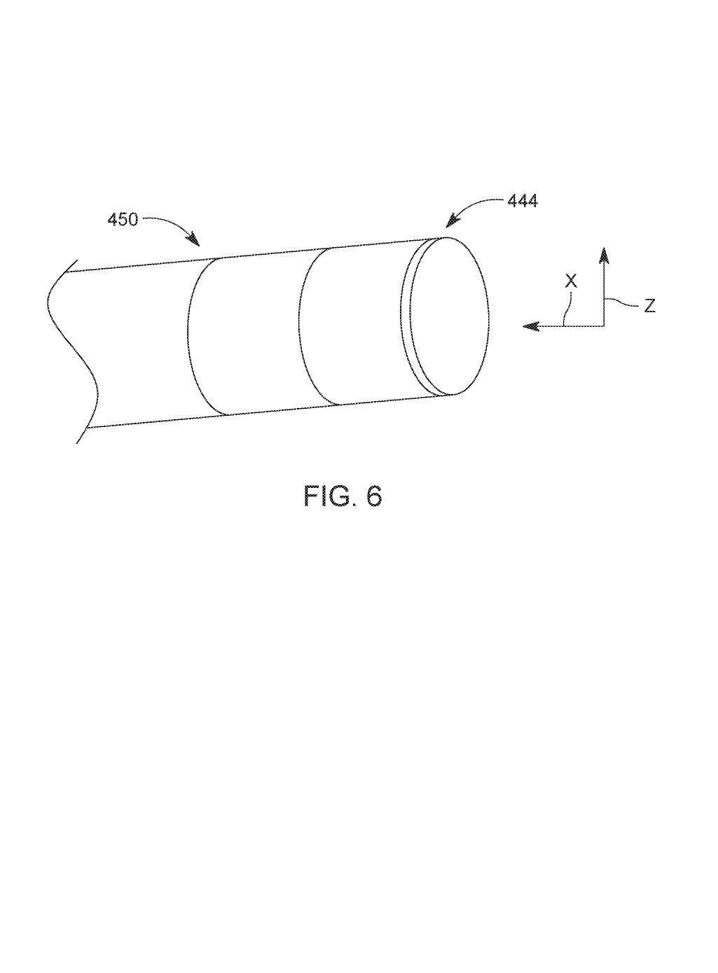

Returning to FIG. 4, the two connecting elements 448 and 450 are made of planar slabs of material (e.g., steel, but other materials are also possible, as composite materials or a mixture of metals and nonmetals). FIG. 4 shows that the bottom part 450-1 and the side parts 450-2 (only one shown in the figure, but there is a similar one facing the opening 446) may be made of a single planar slab of material. However, the top part 450-3 may be made of three distinct elements, two slanted flat portions 450A and 450C and a vertex flat portion 450-B, which is substantially parallel to the bottom plate 450-1. The portions 450A-450C together form a ramp. The term “ramp” is defined in this document to be a shape described by a portion inclined in an upward direction, followed by a horizontal portion, followed by a portion inclined in a downward direction when referred to a given axis (e.g., longitudinal axis X in this embodiment). In one embodiment, the ramp has a symmetric shape (or axis of symmetry), i.e., the portions 450A and 450C have the same size and opposite angles of inclination when referred to a vertical axis Z (the gravity in this embodiment). Note that the two connecting elements 448 and 450 in FIG. 5 are tubular, with the ends shaped to fit on the transversal tubular elements 442 and 444. A detail of this cut is illustrated in FIG. 6. The two connecting elements 448 and 450 are welded in this embodiment to the two transversal tubular elements 442 and 444.

The two transversal tubular elements 442 and 444 may be made of a single tubular part or multiple tubular parts, which are then welded to each other. For example, FIG. 4 shows the first transversal tubular element 442 being made of two parts, a first part 442-1 and a second part 442-1, and these two tubular parts are welded at a seam 443. The same figure shows the second transversal tubular element 444 being made of three parts 444-1-444-3, which are welded to each other to form element 444. While this embodiment uses welding, other connecting means may be used, for example, bolts. FIG. 4 shows that the two parts 442-1 and 442-2 are directly welded to each other. However, the same figure shows that the three parts 444-1-444-3 are not directly welded to each other. The first and second parts 444-1 and 444-2 are (directly) welded to opposite faces of a first longitudinal beam 462 and the second and third parts 444-2 and 444-3 are (directly) welded to opposite faces of a second longitudinal beam 464. The longitudinal beams 462 and 464 are substantially parallel to each other and may extend up to the end of the vibratory truck 300. One or more transversal beams 466 connect the two longitudinal beams 462 and 464 to each other for increasing the strength of the entire chassis 330.

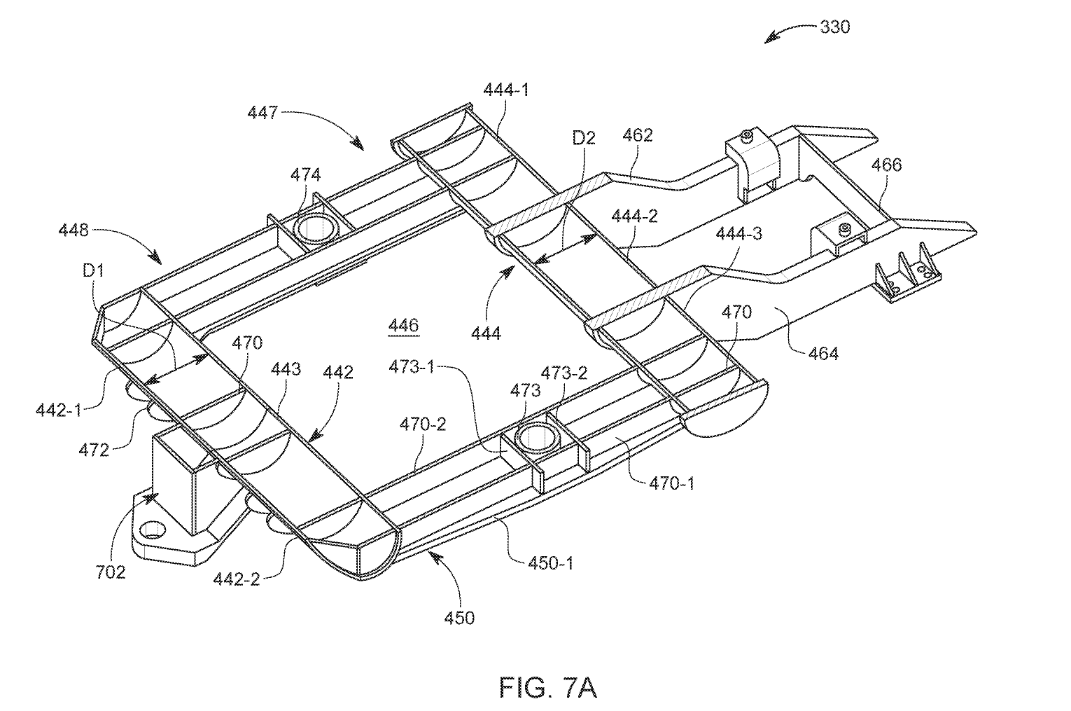

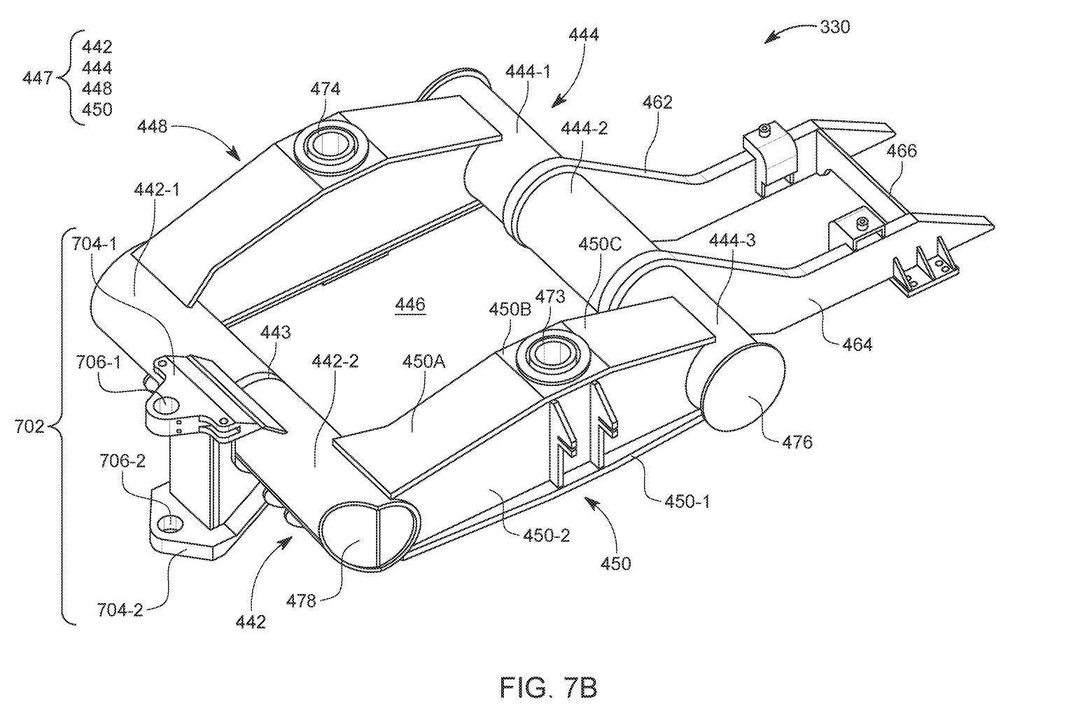

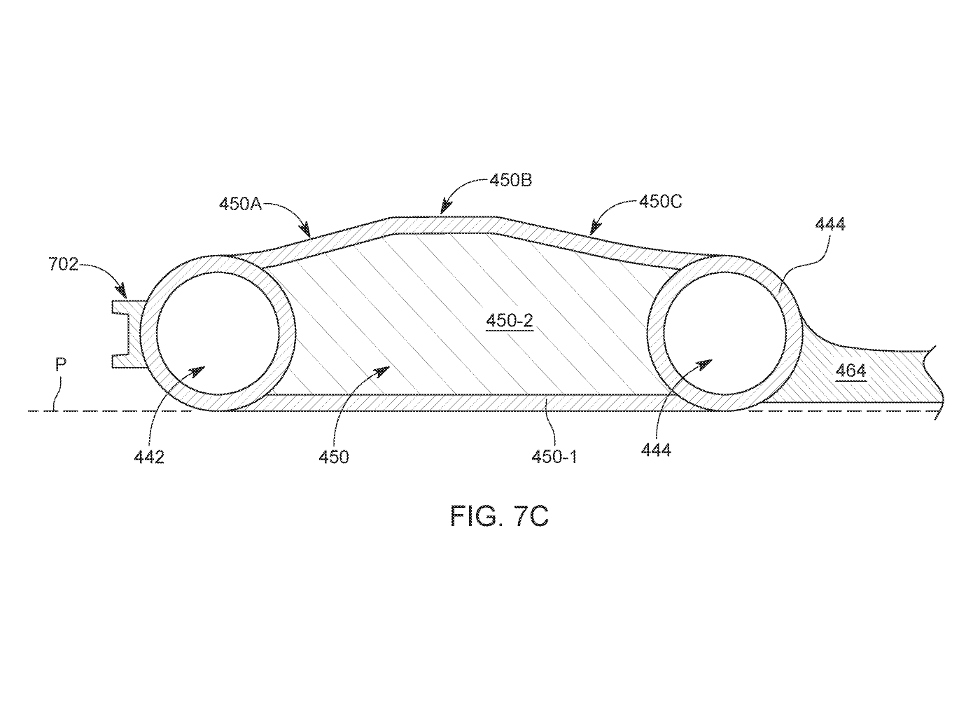

FIGS. 7A-7C illustrate the structure of the planar chassis 330 in more detail. FIG. 7A is a longitudinal cut through the planar chassis 330. This cut illustrates that the parts 442-1, 442-2, 444-1, 444-2, and 444-3 are cylindrical. However, a cross section of these parts may be elliptical. A diameter D1 of the parts 442-1 and 442-1 and a diameter D2 of the parts 444-1-444-3 may be different. In this embodiment, the two diameters D1 and D2 are identical. The diameters D1 and D2 may be about 350-500 mm. In one embodiment, the diameters D1 and D2 are about 457 mm. The thickness of the material making the wall of the tubular elements may be between 20 and 40 mm. In one embodiment, when the diameter is about 457 mm, the wall thickness of the tubular elements is about 30 mm. The parts 442-1, 442-2, 444-1, 444-2, and 444-3 may be enforced by inside plates 470. These plates may be welded to the interior wall of the tubular parts 442-1, 442-2, 444-1, 444-2, and 444-3. Two or more inside plates 470 may be placed inside each tubular part 442-1, 442-2, 444-1, 444-2, and 444-3. In one embodiment, as illustrated in FIG. 7A, exterior ribs 472 may be attached to the lower part of the tubular parts 442-1, 442-2, 444-1, 444-2, and 444-3 to increase their strength. The exterior ribs 472 are made of steel and only partially enclose a diameter of the tubular parts. The exterior ribs 472 may be welded to the tubular parts.

FIG. 7A also shows that the tubular parts 444-1, 444-2, and 444-3 are directly welded to the longitudinal beams 462 and 464. More specifically, the first longitudinal beam 462 is sandwiched welded between the parts 444-1 and 444-2 and the second longitudinal beam 464 is sandwiched welded between the parts 444-2 and 444-3. The figure also shows the inner structure of the connecting elements 448 and 450. Each of the connecting elements 448 and 450 has an inner structure and an outer structure. The outer structure is made up of the plates 450-1, 450-2, 450A, 450B, and 450C shown in FIGS. 4, 7B and 7C. The inner structure is located within the outer structure and includes longitudinal plates 470-1 and 470-2, which are directly welded to the first and second transversal tubular elements 442 and 444. In one embodiment, the base plate 450-1 of the outer structure may be directly welded to the longitudinal plates 470-1 and 470-2.

Support elements 473 and 474 are added to the inner structure for holding the lifting system 310 (not shown). The support elements 473 and 474 may be circular and may be welded to the longitudinal plates 470-1 and 470-2 and/or the base plate 450-1. Strengthening members 473-1 and 473-2 may be welded to the longitudinal plates 470-1 and 470-2 and the support elements 473 and 474 for increasing the strength of the entire structure. The plates 450B, as illustrated in FIG. 7B, may have an opening for allowing the support elements 473 and 474 to exit the outer structure. FIG. 7B also shows that the tubular parts 444-1 and 444-3 have circular caps 476 while the tubular parts 442-1 and 442-2 have non-circular caps 478. In one embodiment, the non-circular caps 478 are made of plural parts.

The chassis 330 shown in FIGS. 7A and 7B has a large opening 446 that, as discussed above, allows the entire baseplate 320 (not shown) to pass through. This large size opening 446 is possible due to the tubular structure of the first and second transversal tubular elements 442 and 444. The elements defining the opening 446 are called herein the “opening defining enclosure” or “cage” 447. The cage 447, which is illustrated in FIG. 7B, includes the transversal tubular elements 442 and 444, and the connecting elements 448 and 450. As illustrated in FIGS. 7B and 7C, the bottom parts of all these elements (442, 444, 448, and 450) that make up the cage 447 are located in a plane P (see FIG. 7C for a better illustration), i.e., there is no arching between these elements, contrary to the chassis configuration shown in FIGS. 1 and 2 discussed above. In one embodiment, the same plane P defines the bottom parts of the first and second longitudinal beams 462 and 464.

FIGS. 3-7C show that the first transversal tubular element 442 is attached (e.g., welded) to a connecting mechanism 702. The connecting mechanism 702, as illustrated in FIG. 7B, includes two parallel and horizontal plates 704-1 and 704-2, each having a corresponding hole 706-1 and 706-2. The connecting mechanism 702 is used to attach the chassis 330 to the cabin part 340 (see FIG. 3) of the vibratory truck 300. FIG. 3 shows the cabin part 340 including the driving cabin 342 and some auxiliary equipment 344 (e.g., a motor, hydraulic or fuel tank, etc.). The same figure shows the chassis 330 supporting the vibratory mechanism 312, the lift system 310, the baseplate 320, and the engine 350 of the truck. Due to the connecting mechanism 702, the cabin part 340 can rotate relative to the chassis 330. The connecting mechanism 702 is attached with one or two pins 352 to the cabin part 340. In one embodiment, there is no other connection between the cabin part 340 and the chassis 330 except for the connecting mechanism 702.

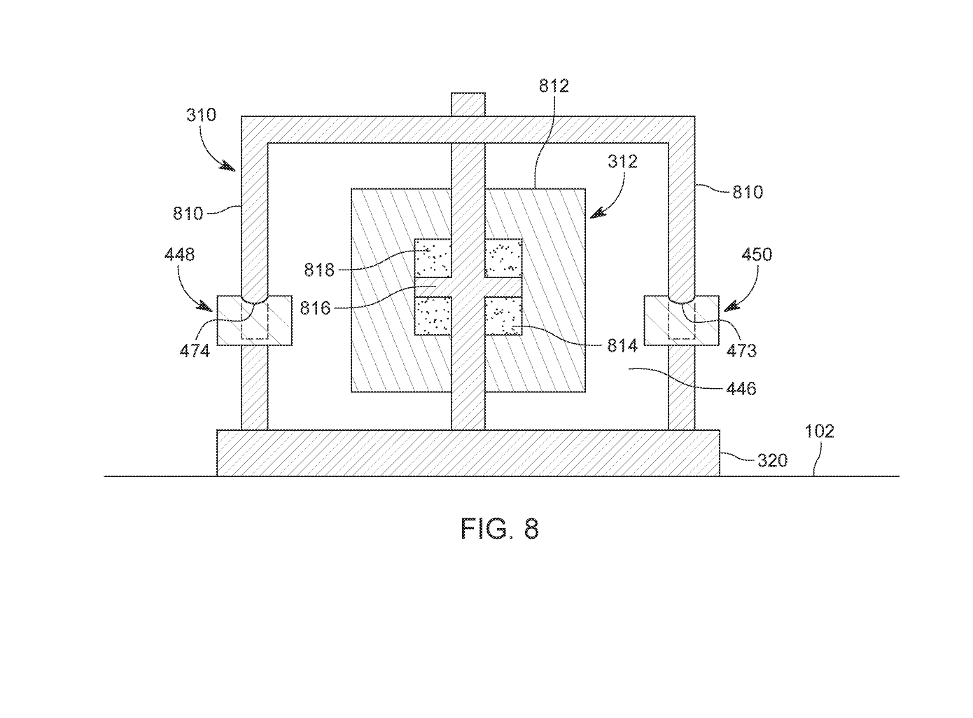

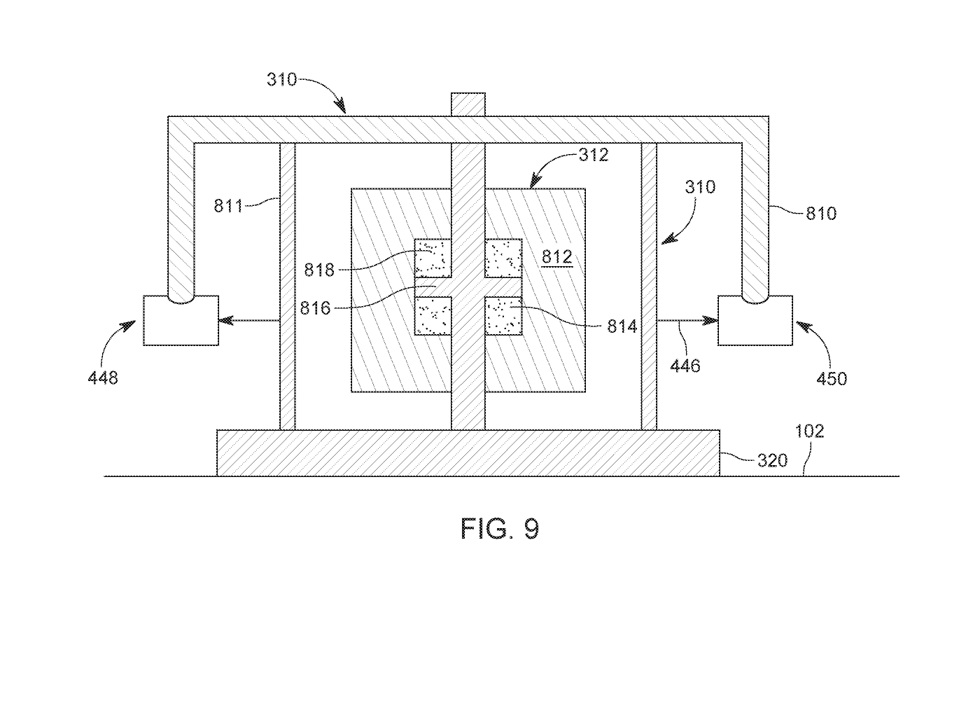

FIG. 8 shows a cross-section through the lift system 310, vibratory mechanism 312, and the connecting elements 448 and 450 and how they are positioned one relative to the other. The figure illustrates that the lift system 310 has members 810 supported (or passing through) by the support elements 473 and 474. The lift system 310 lowers or raises the baseplate 320 as necessary. The figure also shows a reactive mass 812, which is part of the vibratory mechanism 312. The reactive mass 812 has an inside chamber 814, which accommodates a piston 816. The piston is surrounded by a fluid 818, which is housed by the inside chamber 814. Various hoses (not shown) apply a hydraulic pressure to the fluid 818 from a hydraulic pump 314 (see FIG. 3), which is located on the chassis 330. The alternate application of the hydraulic pressure on the opposite faces of the piston 816 makes the reaction mass 812 to oscillate with the desired frequency relative to the piston 816. Note that the piston 816 is fixed relative to the baseplate 320. Because the large mass of the reaction mass 812 hammers the baseplate 320, the baseplate 320 also oscillates with the same frequency. While the embodiment illustrated in FIG. 8 shows the baseplate 320 having a surface area larger than the opening 446, FIG. 9 illustrates an embodiment in which the entire baseplate 320 is capable of passing through the opening 446. For this embodiment, the lift system 310 has additional arms 811 for raising and lowering the baseplate 320. Note that when the vibratory truck 300 is traveling from one shot point to another one, the baseplate 320 together with the vibratory mechanism 312 is raised through the opening 446.

When the vibratory truck 300 arrives at the next shot point, the baseplate 320 together with the vibratory mechanism 312 is lowered (by the lift system 310) so that the baseplate 320 is in direct contact with the ground 102. The lift system 310 is further configured to raise the truck (and implicitly the cabin part 340 and the chassis 330) from the ground, so that part of the entire weight of the truck is acting on the baseplate 320. Then, the vibratory mechanism 312 actuates the reaction mass 812 to impart the desired energy to the baseplate 320, which imparts the energy to the ground, to generate the seismic waves. Both FIGS. 8 and 9 show the baseplate 320 in direct contact with the ground.

By using the above flat chassis with tubular elements, the size of the opening 446 may be made large enough so that the entire baseplate assembly (i.e., baseplate 320 and the vibratory mechanism 312) may travel through the opening, for various masses of the vibratory assembly. Because the elements of the chassis defining the opening 446 are at least partially tubular, a shape that increases their strength relative to the traditional flat elements, the movement of the heavy reaction mass will not damage the flat chassis 330. Thus, it is possible to use the same chassis 330 for large (9 ton) and extra-large (12 ton) reactions masses. Due to the increased strength of the tubular elements, the part of the chassis defining the opening 446 may have a flat bottom portion, which simplifies the manufacturing of the chassis 330. For this embodiment, the vibratory mechanism 312 and the baseplate 320 may be removed from the chassis 330 and another size vibratory mechanism 312 and baseplate 320 may be connected, as the seismic survey requires. This is possible because the baseplate 320 and the vibratory mechanism 312 have minimal connections to the chassis 330. In other words, the flat chassis 330 is configured to receive one of multiple baseplate assemblies, with various masses. This means that a same vibratory truck 300 may be used for diverse seismic survey acquisitions campaigns, but simply changing the baseplate assembly as required by each survey.

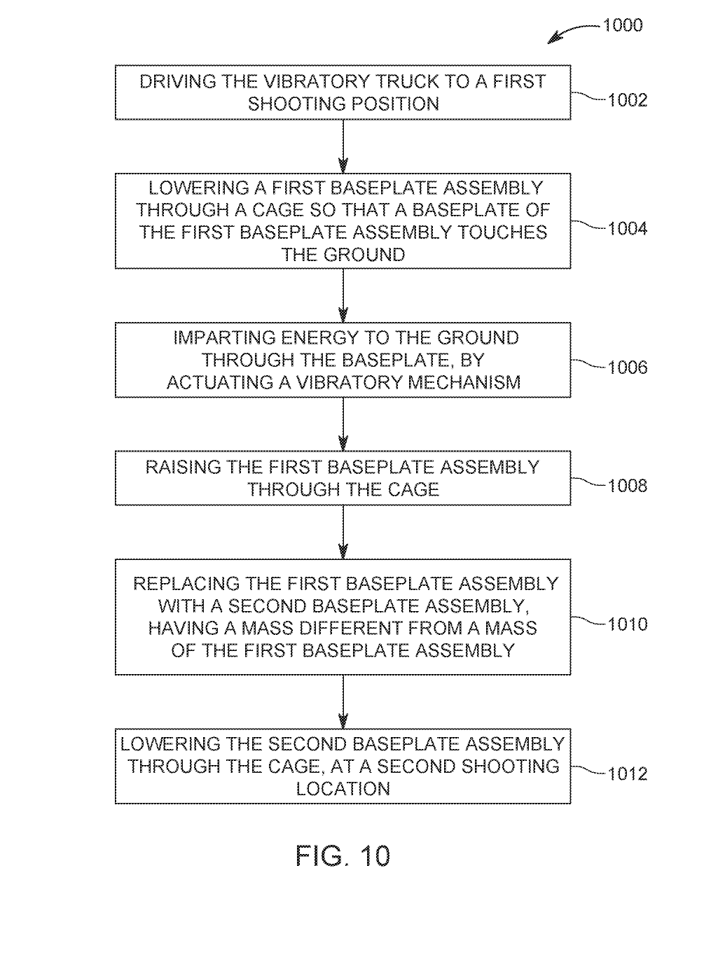

A method for using the vibratory truck 300 is now discussed with regard to FIG. 10. The method 1000 includes a step 1002 of driving the vibratory truck 300 to a first shooting position, a step 1004 of lowering a first baseplate assembly through a cage 447 so that a baseplate 320 of the first baseplate assembly touches the ground, a step 1006 of imparting energy to the ground through the baseplate 320, by actuating a vibratory mechanism 312, a step 1008 of raising (partially or totally) the first baseplate assembly through the cage 447, a step 1010 of replacing the first baseplate assembly with a second baseplate assembly, having a mass different from a mass of the first baseplate assembly, and a step 1012 of lowering the second baseplate assembly through the cage 447, at a second shooting location. In one application, the mass of the first baseplate assembly is about 9 tons and a mass of the second baseplate assembly is about 12 tons. Other values for the masses of the first and second baseplate assemblies may be used. In this embodiment, the cage is sized to allow each of the first and second baseplate assembly to pass through its opening. In one application, the bottom of the cage extends into a plane, i.e., it is flat. In another application, the cage and the entire chassis of the vibratory truck is flat.

The disclosed embodiments provide a flat truck chassis for supporting a baseplate assembly having different weights. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A vibratory truck chassis for supporting a baseplate assembly for generating seismic signals, the vibratory truck chassis comprising:
a cage having a flat bottom, the cage defining an opening;
first and second longitudinal beams each attached with one end to the cage; and
a connecting mechanism attached to the cage and configured to attach the chassis to a cabin part of a truck.

2. The chassis of claim 1, wherein the cage includes first and second transversal tubular elements, each transversal to a longitudinal axis of the chassis.

3. The chassis of claim 2, wherein the cage further includes first and second connecting elements attached to the first and second transversal tubular elements to define the opening.

4. The chassis of claim 3, wherein the first and second connecting elements are tubular.

5. The chassis of claim 3, wherein the first transversal tubular element is attached to the connecting mechanism and the second transversal tubular element is connected to the first and second longitudinal beams.

6. The chassis of claim 5, wherein the first transversal tubular element is made of two tubular parts welded together, and each tubular part is reinformed with internal plates.

7. The chassis of claim 5, wherein the second transversal tubular element is made of three tubular parts, and each tubular part is welded to at least one of the first and second longitudinal beams.

8. The chassis of claim 5, wherein each of the first and second connecting elements includes an inner structure and an outer structure.

9. The chassis of claim 8, wherein the inner structure includes two parallel plates and the outer structure includes a bottom plate, side plates, and a top plate, and the top plate is made of a two slanted portions and one vertex portion parallel to the bottom plate.

10. The chassis of claim 9, wherein the two slanted portions and vertex portion are shaped as a ramp having an axis of symmetry.

11. A vibratory truck for supporting a baseplate assembly for generating seismic signals, the vibratory truck comprising:
a flat chassis having a cage with a flat bottom, the cage defining an opening;
a baseplate for contacting a ground; and
a vibratory mechanism configured to act on the baseplate to generate the seismic signals,
wherein the opening is sized to allow the baseplate and the vibratory mechanism to fully pass through the opening for various weights of the baseplate and the vibratory mechanism.

12. The vibratory truck of claim 11, wherein the flat chassis further includes:
first and second longitudinal beams each attached with one end to the cage; and
a connecting mechanism attached to the cage and configured to attach the chassis to a cabin part of the vibratory truck.

13. The chassis of claim 12, wherein the cage includes first and second transversal tubular elements, each transversal to a longitudinal axis of the chassis.

14. The chassis of claim 13, wherein the cage further includes first and second connecting elements attached to the first and second transversal tubular elements to define the opening.

15. The chassis of claim 14, wherein the first and second connecting elements are tubular.

16. The chassis of claim 14, wherein the first transversal tubular element is attached to the connecting mechanism and the second transversal tubular element is connected to the first and second longitudinal beams.

17. The chassis of claim 16, wherein the first transversal tubular element is made of two tubular parts welded together, and each tubular part is reinforced with internal plates.

18. The chassis of claim 16, wherein the second transversal tubular element is made of three tubular parts, and each tubular part is welded to at least one of the first and second longitudinal beams.

19. The chassis of claim 16, wherein each of the first and second connecting elements includes an inner structure and an outer structure.

20. The chassis of claim 19, wherein the inner structure includes two parallel plates and the outer structure includes a bottom plate, side plates, and a top plate, and the top plate is made of a two slanted portions and one vertex portion parallel to the bottom plate.
